(19) United States
(12) Patent Application Publication
(10) Pub. No.: US 2025/0095104 A1
(43) Pub. Date: Mar. 20, 2025

(54) IMAGE SIGNAL PROCESSOR AND IMAGE SIGNAL PROCESSING METHOD

(71) Applicant: SK hynix Inc., Gyeonggi-do (KR)

(72) Inventor: Yuuki ADACHI, Tokyo (JP)

(21) Appl. No.: 18/801,852

(22) Filed: Aug. 13, 2024

(30) Foreign Application Priority Data
Sep. 15, 2023 (KR) 10-2023-0123383

(51) Int. Cl. G06T 5/20

(52) U.S. Cl. CPC G06T 5/20

(57) ABSTRACT

An image signal processor includes a directional component extractor configured to extract directional components of a target kernel by performing a convolution operation between the target kernel including a target pixel and each of a plurality of directional kernels, an interpolation kernel determiner configured to determine an interpolation kernel based on the directional components, and a pixel interpolator configured to interpolate the target pixel using data included in the interpolation kernel.

### CROSS-REFERENCE TO RELATED APPLICATION

This patent application claims the priority and benefits of Korean patent application No. 10-2023-0123383, filed on Sep. 15, 2023, the disclosure of which is incorporated herein by reference in its entirety.

### TECHNICAL FIELD

Embodiments of the present disclosure generally relate to an image signal processor capable of performing image conversion and an image signal processing method for the same.

### BACKGROUND

An image sensing device is a device for capturing optical images by converting light into electrical signals using a photosensitive semiconductor material which reacts to light. With the development of the automotive, medical, computer and communication industries, the demand for high-performance image sensing devices has been increasing in various fields such as smart phones, digital cameras, game machines, Internet of Things (IoT), robots, surveillance cameras and medical micro cameras.

An original image captured by the image sensing device may include a plurality of pixels corresponding to different colors (e.g., red, blue, and green). The plurality of pixels included in the original image may be arranged according to a certain color pattern (e.g., RGBW pattern). In order to convert the original image into a complete image (e.g., RGBW images), an operation of interpolating pixels may be performed according to a predetermined algorithm. This algorithm basically includes an operation of interpolating pixels having lost (or missed) information using information of the neighboring pixels.

### SUMMARY

In accordance with an embodiment of the present disclosure, an image signal processor may include a directional component extractor configured to extract directional components of a target kernel by performing a convolution operation between the target kernel including a target pixel and each of a plurality of directional kernels, an interpolation kernel determiner configured to determine an interpolation kernel based on the directional components, and a pixel interpolator configured to interpolate the target pixel using data included in the interpolation kernel.

In accordance with another embodiment of the present disclosure, an image signal processor may include: a directional component extractor configured to extract directional components of a target kernel by performing a first convolution operation between the target kernel and each of a plurality of first kernels, the target kernel including a target pixel; an interpolation kernel determiner configured to obtain convolution resultant values by performing a second convolution operation between each of a plurality of second kernels and the directional components; and a pixel interpolator configured to interpolate the target pixel using data included in the interpolation kernel.

In accordance with another embodiment of the present disclosure, an image signal processing method may include extracting first directional components of a first color kernel by performing a convolution operation between the first color kernel and each of a plurality of directional kernels, the first color kernel including a first target pixel, determining a first interpolation kernel based on the first directional components, and interpolating the first target pixel using data included in the first interpolation kernel.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an image signal processor based on some embodiments of the present disclosure.

FIG. 2 is a block diagram illustrating a defective pixel corrector shown in FIG. 1 based on some embodiments of the present disclosure.

FIG. 3 is a flowchart illustrating an operation of a defective pixel corrector shown in FIG. 2 based on some embodiments of the present disclosure.

FIG. 4A is a diagram illustrating a plurality of directional kernels based on some embodiments of the present disclosure.

FIG. 4B is a diagram illustrating a method for performing the operation S100 shown in FIG. 3 based on some embodiments of the present disclosure.

FIG. 5A illustrates a formula showing a plurality of cost kernels based on some embodiments of the present disclosure.

FIG. 5B is a diagram illustrating a plurality of cost kernels based on some embodiments of the present disclosure.

FIG. 5C is a diagram illustrating a method for performing the operation S120 shown in FIG. 3 based on some embodiments of the present disclosure.

FIG. 6A is a diagram illustrating a plurality of interpolation kernels based on some embodiments of the present disclosure.

FIG. 6B is a diagram illustrating a method for performing the operation S150 shown in FIG. 3 based on some embodiments of the present disclosure.

FIG. 7 illustrates a formula showing the entire process of interpolating one pixel based on some embodiments of the present disclosure.

FIG. 8 is a diagram illustrating the entire process of interpolating one pixel based on some embodiments of the present disclosure.

FIG. 9 is a flowchart illustrating a method for interpolating a target kernel by classifying kernels by color based on some embodiments of the present disclosure.

FIG. 10 is a block diagram illustrating a computing device corresponding to the image signal processor of FIG. 1 based on some embodiments of the present disclosure.

### DETAILED DESCRIPTION

Embodiments of the present disclosure provide implementations and examples of an image signal processor and an image signal processing method capable of increasing the accuracy of correction for defective pixels or the like, that may be used in configurations to substantially address one or more technical or engineering issues and to mitigate limitations or disadvantages encountered in some image signal processors in the art. Some embodiments of the present disclosure relate to an image signal processor and an image signal processing method that can increase the accuracy of correction for defective pixels or the like. In recognition of the issues above, the image signal processor and the image signal processing method based on some embodiments of the present disclosure can analyze directional components included in a target kernel, can interpolate the target kernel based on an interpolation kernel corresponding to the target kernel, and can thus increase the accuracy of correction for defective pixels even when multiple directional components are included in the target kernel. Generally, in image processing, interpolation is a technique used to estimate the values of pixels at non-integer coordinates within an image. When resizing or transforming an image, the resulting pixel positions may not align with the original pixel grid. Interpolation helps to estimate the intensity values for these non-integer pixel positions based on known values of neighboring or other pixels.

Reference will now be made in detail to some embodiments of the present disclosure, examples of which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the present disclosure may provide a variety of effects capable of being directly or indirectly recognized through the disclosed technology.

Various embodiments of the present disclosure relate to an image signal processor capable of increasing the accuracy of correction for defective pixels or the like, and an image signal processing method for the same.

It is to be understood that both the foregoing general description and the following detailed description of the present disclosure are illustrative and descriptive, and are intended to provide further description of the embodiments as claimed.

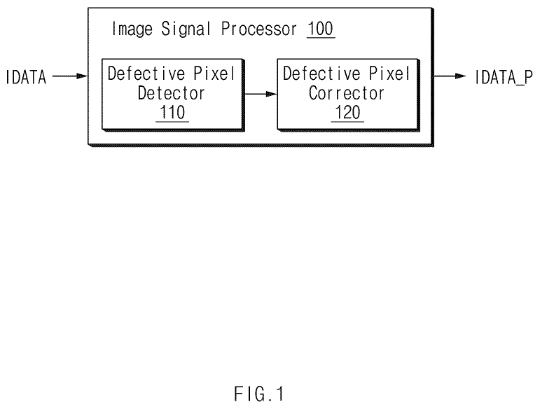

FIG. 1 is a block diagram illustrating an image signal processor 100 based on some embodiments of the present disclosure.

Referring to FIG. 1, the image signal processor (ISP) 100 may perform at least one image signal process on image data (IDATA) to generate the processed image data (IDATA_P). The image signal processor 100 may reduce noise of image data (IDATA), and may perform various types of image signal processing (e.g., demosaicing, defective pixel correction, gamma correction, color filter array interpolation, color matrix, color correction, color enhancement, lens distortion correction, etc.) for image-quality improvement of the image data. In addition, the image signal processor 100 may compress image data that has been created by execution of image signal processing for image-quality improvement, such that the image signal processor 100 can create an image file using the compressed image data. Alternatively, the image signal processor 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene, but the scope of the disclosed technology is not limited thereto. In an embodiment, the image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some embodiments of the present disclosure, the image data (IDATA) is generated by the image sensing device.

The pixel array of the image sensing device may include defective pixels that cannot normally capture a color image due to process limitations or temporary noise inflow. In addition, the pixel array may include phase difference detection pixels configured to acquire phase difference-related information to implement the autofocus function. The phase difference detection pixels cannot acquire color images in the same manner as defective pixels, such that the phase difference detection pixels can be treated as defective pixels from the point of view of color images. In some embodiments, for convenience of description and better understanding of the disclosed technology, the defective pixel and the phase difference detection pixel, each of which cannot normally acquire the color image, will hereinafter be collectively referred to as “defective pixels”.

In order to increase the quality of color images, it is essential to improve the accuracy of correction of defective pixels. To this end, the image signal processor 100 based on some embodiments of the present disclosure may include a defective pixel detector 110 and a defective pixel corrector 120.

The defective pixel detector 110 may detect pixel data of the defective pixel from the image data (IDATA). In some embodiments of the present disclosure, for convenience of description, digital data corresponding to a pixel signal of each pixel will hereinafter be defined as pixel data, and a set (or aggregate) of pixel data corresponding to a predetermined unit (e.g., a frame or kernel) will hereinafter be defined as image data (IDATA). Here, the frame may correspond to the entire pixel array, and the kernel may refer to a unit for image signal processing.

In some embodiments, the defective pixel detector 110 may detect pixel data of the defective pixel based on the image data (IDATA). For example, the defective pixel detector 110 may calculate a difference between pixel data of a target pixel and an average value of pixel data. Here, the pixel data of a target pixel is to be used as a target for determining whether or not the corresponding pixel is a defective pixel, and the average value of pixel data belongs to a kernel. Further, the defective pixel detector 110 may determine whether the target pixel is a defective pixel based on the calculated difference. That is, the defective pixel detector 110 may determine that the target pixel is a defective pixel having no normal pixel data when a difference between the pixel data of the target pixel and the average value of pixel data belonging to the kernel is greater than or equal to a predetermined threshold value. In some embodiments, a predetermined threshold value may be a fixed constant, or may be a specific ratio of a brightness value (e.g., a green average value) of a current kernel.

In some other implementations, the defective pixel detector 110 may receive pre-stored position information of defective pixels from the image sensing device that generates image data (IDATA). Further, the defective pixel detector 110 may determine whether the target pixel is a defective pixel based on the position information of the defective pixels. The image sensing device may store in an internal storage position information of fixed defective pixels due to fabrication process reasons. In some embodiments, the internal storage may be one time programmable (OTP) memory. Further, the image sensing device may provide the position information of the defective pixels to the image signal processor 100.

When it is determined that the target pixel is a defective pixel by the defective pixel detector 110, the defective pixel corrector 120 may correct pixel data of the target pixel based on image data of a kernel including the target pixel.

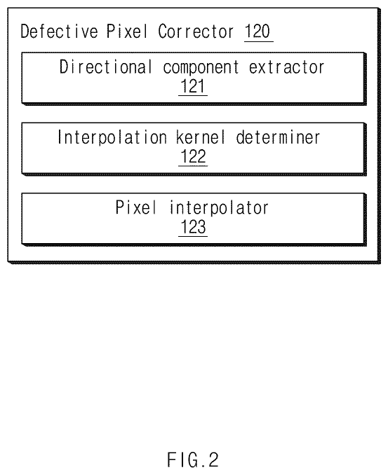

Referring to FIG. 2, the defective pixel corrector 120 may include a directional component extractor 121, an interpolation kernel determiner 122, and a pixel interpolator 123.

Image data (IDATA) corresponding to one frame may include directional components of various sizes and shapes. The directional component may mean that a set (or aggregate) of pixels having similarity from among adjacent pixels of the target pixel is quantified in terms of size and/or direction. For example, a subject having a unified color included in a captured scene may be recognized as a directional component. For example, when pixels having unified color from among adjacent pixels located around the target pixel are arranged in a horizontal direction and a boundary between the pixels having unified color is clear, this means that the corresponding directional component has a horizontal directionality and a high directionality value. In some embodiments, the directional component may include a horizontal direction, a vertical direction, or a diagonal direction, and may not include a target pixel. For example, the directional component may be located in a target kernel including the target pixel, and may include a stripe pattern, a corner pattern, and/or the like, each of which does not include the target pixel. The directional component extractor 121 may extract directional components corresponding to the target pixel included in the target kernel. In one example, the directional component extractor 121 may perform a convolution operation between the target kernel and each of the plurality of directional kernels to extract directional components corresponding to a target pixel included in the target kernel. In the context of image processing, a convolution operation is often used for tasks such as edge detection, blurring, sharpening, and feature extraction. Convolution works by defining a small matrix (also known as a kernel or filter). This matrix is typically much smaller than the input image. The kernel is slid or convolved across the entire input image. At each position, the element-wise multiplication of the kernel and the overlapped portion of the image is computed. The results of the element-wise multiplications are then summed up to produce a single value. This result is typically placed in a new image, often called the output or feature map. The convolution operation is usually repeated for every position in the input image, and the result is a new image (feature map) that may highlight specific features depending on the chosen kernel. Directional components corresponding to the target pixel included in the target kernel may reflect characteristics of various directional kernels. For example, the directional component extractor 121 may extract a directional component of the diagonal direction by performing a convolution operation between the target kernel and the diagonal directional kernel. Furthermore, the directional component extractor 121 may extract more diverse directional components by combining directional kernels. For example, when the target kernel includes both the diagonal directional component and the horizontal directional component, the directional component extractor 121 may selectively combine the diagonal directional kernel and the horizontal directional kernel. For example, a kernel that includes 1 value included in the horizontal direction kernel and 1 value included in the slash direction kernel as 1 value may correspond to a kernel that can extract a direction having a direction halfway between the horizontal direction and the slash direction. Further, the directional component extractor 121 may multiply the combined kernel by a preset weight, and may extract costs of new directional components into which the diagonal directional component and the horizontal directional component are reflected. Costs related to directional components can be associated with various image processing tasks and often pertain to optimization or energy minimization issues. Some examples of costs in image processing are computational costs, memory costs, filter designs, feature redundancy, noise sensitivity, computational efficiency, parameter tuning such as the size of the convolutional kernel, and the like.

The interpolation kernel determiner 122 may extract a cost according to a combination of directional components based on the extracted directional components. In one example, the interpolation kernel determiner 122 may perform a convolution operation between each of the directional components and each of a plurality of cost kernels to extract costs according to the combination of directional components.

The interpolation kernel determiner 122 may determine, based on the extracted costs, an interpolation kernel corresponding to a target pixel included in the target kernel. In one example, the interpolation kernel determiner 122 may determine, as an interpolation kernel corresponding to a target pixel, an interpolation kernel corresponding to a cost kernel that derives a maximum or minimum value (i.e., a maximum or minimum cost value) from among the extracted costs.

The pixel interpolator 123 may interpolate pixel data of a target pixel included in the target kernel based on the interpolation kernel determined by the interpolation kernel determiner 122. In one example, the pixel interpolator 123 may match, with the target pixel, data located at the center of the interpolation kernel determined by the interpolation kernel determiner 122. Further, the pixel interpolator 123 may perform a convolution operation between the target kernel and the interpolation kernel, and may determine the convolution resultant value to be pixel data of the target pixel.

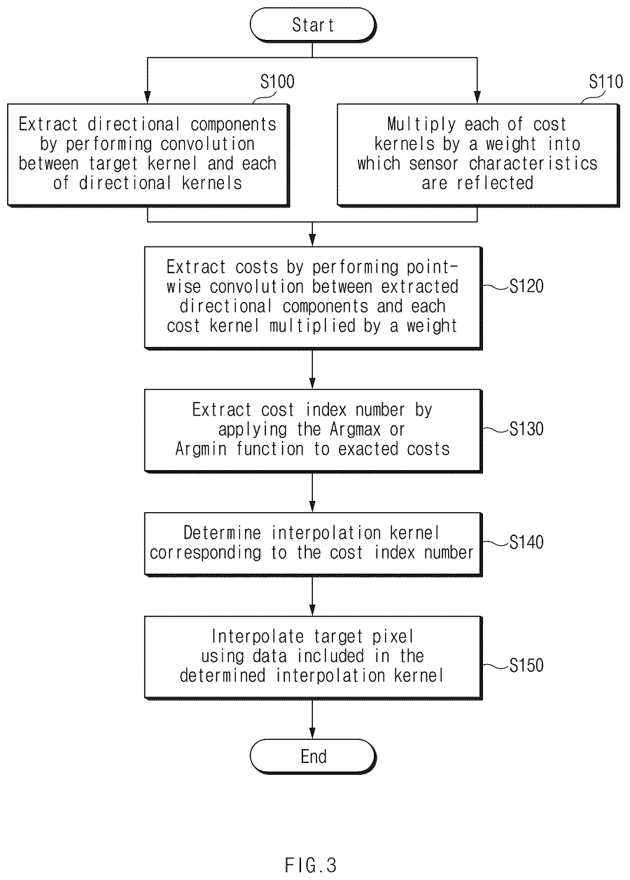

FIG. 3 is a flowchart illustrating an operation of a defective pixel corrector 120 shown in FIG. 2 based on some embodiments of the present disclosure.

Referring to FIG. 3, the operation of the defective pixel corrector 120 may include extracting directional components for a target kernel including a target pixel DP (S100), determining an interpolation kernel based on the extracted directional components and the plurality of cost kernels (S140), and interpolating the target pixel DP using data included in the determined interpolation kernel (S150).

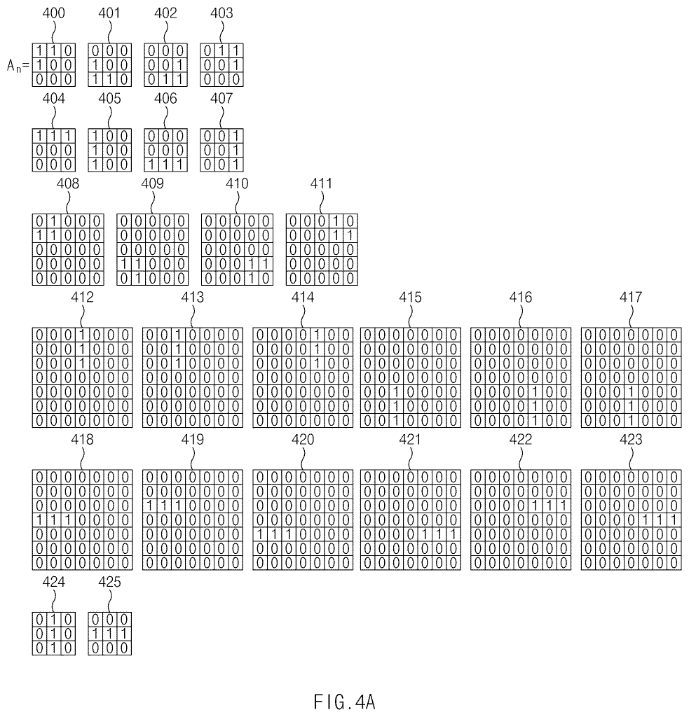

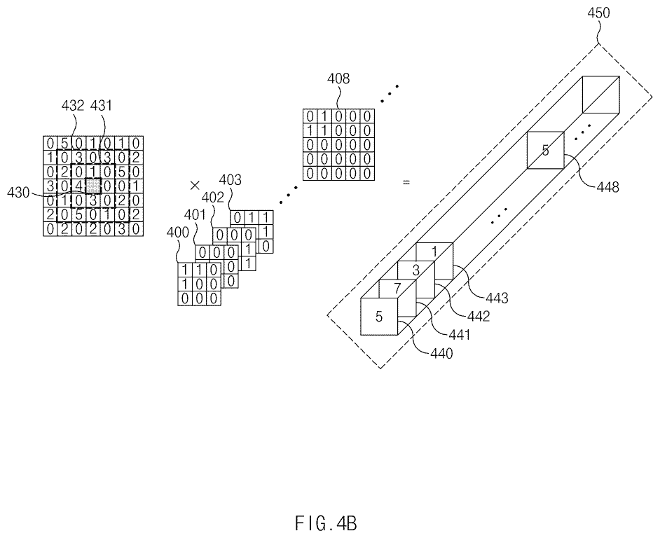

In FIGS. 3 to 9, a method for correcting a defective pixel using a kernel indicating a RGBW pattern as an example will hereinafter be described in detail. For example, the RGBW pattern may be a kernel that includes red pixels, green pixels, blue pixels, and white pixels. In addition, the target pixel is located at the center of the target kernel. As shown in the example of FIG. 4B, when the target kernel is a (5×5) kernel that includes the first to 25^{th} pixels, the target pixel may correspond to a pixel located at the position of the thirteenth pixel. The red pixel (R) may generate red pixel data by detecting red light, the green pixel (G) may generate green pixel data by detecting green light, the blue pixel (B) may generate blue pixel data by detecting blue light, and the white pixels may generate white pixel data by detecting white light. In addition, each of the red pixel data, the green pixel data, the blue pixel data, and the white pixel data has a range of 0 to 1023.

Although an embodiment of the present disclosure has disclosed that the image is a (5×5)-sized kernel having 25 pixels arranged in the RGBW pattern, as shown in FIG. 4B, for convenience of description, the technical idea of the disclosed technology can also be applied to another kernel in which color pixels are arranged in other patterns such as a Bayer pattern, a Quad-Bayer pattern, a Nona-Bayer pattern, a Hexa-Bayer pattern, a mono pattern, etc. The types of image patterns are not limited thereto and can also be sufficiently changed as needed. In addition, a kernel having another size (e.g., a (3×3) size and a (10×10) size) other than the (5×5) size may be used depending on performance of the image signal processor 100, required correction accuracy, an arrangement method of color pixels, and the like.

The directional component extractor 121 may extract directional components of the target kernel by performing a convolution operation between the target kernel and each of the plurality of directional kernels (S100). For example, the directional component extractor 121 may extract a first directional component by performing a convolution operation between the target kernel and the first directional kernel, may extract a second directional component by performing a convolution operation between the target kernel and the second directional kernel, and may extract a third directional component by performing a convolution operation between the target kernel and the third directional kernel.

The interpolation kernel determiner 122 may multiply each of the cost kernels by a weight into which characteristics of each sensor are reflected (S110). Further, the interpolation kernel determiner 122 may extract a plurality of costs by performing a point-wise convolution between each of the cost kernels multiplied by the weight in operation S110 and each of the directional components extracted in operation S100 (S120). In general, a point-wise convolution is a type of convolution operation in image processing that uses a 1×1 filter kernel instead of larger filter kernels. This means that the filter only considers one pixel at a time along each dimension. For example, the interpolation kernel determiner 122 may multiply the first cost kernel by a first weight and may multiply the second cost kernel by a second weight. For example, the interpolation kernel determiner 122 may extract a first cost by performing a wise convolution operation between the first cost kernel multiplied by the first weight and each of the first to third directional components and may extract a second cost by performing a wise convolution operation between the second cost kernel multiplied by the second weight and each of the first to third directional components.

The interpolation kernel determiner 122 may extract a cost index number by applying the function “Arg max” or “Arg min” to the costs extracted in operation S120 (S130). The Arg max function may correspond to a function for extracting an index number of a highest value among a plurality of costs extracted as a result of the convolution. For example, if the costs of 1, 2, 3, 0, 1, 4, 2 are extracted as a result of the convolution, 6 may be derived when the Arg max function is applied to 1, 2, 3, 0, 1, 4, and 2. This is because cost 4 is the largest value, and the digit thereof is 6. The Arg min function is a function for extracting an index number of a low value, and a specific operation corresponds to Arg max. Further, the interpolation kernel determiner 122 may determine an interpolation kernel corresponding to the index number extracted in operation S130 (S140). For example, the interpolation kernel determiner 122 may extract an index number ‘1’ corresponding to the first cost by applying the function “Arg max” or “Arg min” to the first cost and the second cost, and may determine a first interpolation kernel corresponding to the index number ‘1’.

The pixel interpolator 123 may interpolate the target pixel using data included in the interpolation kernel determined in operation S140 (S150). For example, the pixel interpolator 123 may interpolate the target pixel by performing a convolution operation between the target kernel and the data included in the first interpolation kernel determined in operation S140.

In some embodiments, in the image signal processor (ISP) 100, the directional component extractor 121 may extract directional components of the target kernel by performing a convolution operation between a target kernel including a target pixel and each of a plurality of directional kernels. The interpolation kernel determiner 122 may determine an interpolation kernel based on the directional components. The pixel interpolator 123 may interpolate the target pixel using data included in the interpolation kernel.

More detailed operations of the defective pixel corrector 120 will be described later with reference to the drawings below FIG. 4A.

FIG. 4A is a diagram illustrating a plurality of directional kernels (400˜425) based on some embodiments of the present disclosure.

Referring to FIG. 4A, examples of the directional kernels (400˜425) are shown. A_n is a symbol for multiple direction kernels, for example, A_5 corresponds to the sixth direction kernel 405. In one example, the directional kernels of FIG. 4A may perform a convolution operation between the target kernel and each of the directional kernels such that the center of the kernel can correspond to a target pixel (DP). In some embodiments, the target kernel and the direction kernel may be convolution-operated by matching the position of the pixel located in the center of the direction kernels shown in FIG. 4A with the position of the DP of the target kernel. In one example, the sizes of the directional kernels may be matched with each other by zero-padding the edge portions of the directional kernels, each of which has a smaller size than the largest directional kernel. In one example, the size of the target kernel can be matched with the size of the largest directional kernel. In one example, the first to eighth directional kernels (400˜407) may include data corresponding to a corner portion or an edge portion with respect to the center of the kernel, so that the first to eighth directional kernels (400˜407) may correspond to directional kernels that can extract components of the corner or edge portion located around the target pixel (DP). In one example, the ninth to twelfth directional kernels (408˜411) may include data corresponding to the corner portion excluding a vertex portion with respect to the center of the kernel, and may correspond to the directional kernels that can extract components of the corner portion excluding the vertex portion located around the target pixel (DP). In one example, the thirteenth to twenty-fourth directional kernels (412˜423) may include data corresponding to a line shape, so that the thirteenth to twenty-fourth directional kernels (412˜423) may correspond to the directional kernels capable of extracting line-shaped components (i.e., linear components) located around the target pixel (DP). In one example, each of the twenty-fifth directional kernel 424 and the twenty-sixth directional kernel 425 may include data corresponding to a line shape crossing the kernel, so that the twenty-fifth and twenty-sixth directional kernels (424, 425) may correspond to directional kernels that can extract line-shaped components crossing the target pixel (DP). The directional kernels shown in FIG. 4A are merely examples, and there may exist various kernels filled with dots, lines, faces, or patterns.

Although in the present embodiment a kernel is implemented as a (3×3) kernel, a (5×5) kernel, or a (7×7) kernel for convenience of description, more diverse directional kernels may exist in a kernel larger than the above-described example kernels. The convolution operation according to an embodiment of the present disclosure can be applied substantially in the same way to these directional kernels.

FIG. 4B is a diagram illustrating a method for performing the operation S100 shown in FIG. 3 based on some embodiments of the present disclosure.

Referring to FIG. 4B, the directional component extractor 121 may extract the directional components 450 by performing a convolution operation between the target kernel and each of the directional kernels (e.g., 400, 401, 402, 403, or 408). For example, in order to extract the directional components 450 centered on the target pixel 430, the directional component extractor 121 may extract the first directional component 440 by performing a convolution operation between the target pixel 430 and the first directional kernel 400. At this time, the convolution resultant value obtained by performing a convolution operation between the first directional kernel 400 and pixel data of the neighboring pixels 431 corresponding to the size of the first directional kernel 400 with respect to the target pixel 430 may be denoted by “0×1+1×1+0×0+4×1+0×0+0×0+3×0+0×0=5”, and data of the first directional component 440 may be defined as ‘5’.

In one example, in order to extract directional components 450 centered on the target pixel 430, the directional component extractor 121 may extract the second directional component 441 by performing a convolution operation between the target pixel 430 and the second directional kernel 401. At this time, the convolution resultant value obtained by performing a convolution operation between the second directional kernel 401 and pixel data of the neighboring pixels 431 corresponding to the size of the second directional kernel 401 with respect to the target pixel 430 may be denoted by “0×0+1×0+0×0+4×1+0×0+0×1+3×1+0×0=7”, and data of the second directional component 441 may be defined as ‘7’.

In one example, in order to extract directional components 450 centered on the target pixel 430, the directional component extractor 121 may extract the ninth directional component 448 by performing a convolution operation between the target pixel 430 and the ninth directional kernel 408. At this time, the convolution resultant value obtained by performing a convolution operation between the ninth directional kernel 408 and pixel data of the neighboring pixels 432 corresponding to the size of the ninth directional kernel 408 with respect to the target pixel 430 may be denoted by “0×0+3×1+0×0+3×0+0×0+2×1+0×1+1×0+0×0+5×0+0×0+4×0+0×0+0×0+1×0+0×0+3×0+0×0+2×0+0×0+5×0+0×0+1×0+0×0=5”, and data of the ninth directional component 448 may be defined as ‘5’.

The directional component extractor 121 may stack each of the directional components (e.g., 440, 441, 442, 443, or 448), and may express the stacked result as the directional components 450 formed in a three-dimensional (3D) stack kernel shape. Each of the directional components (e.g., 440, 441, 442, 443, or 448) may correspond to each of the directional kernels (e.g., 400, 401, 402, 403, or 408).

In some embodiments, the size of the target kernel may be set to the same size as the size of the largest directional kernel from among the plurality of directional kernels.

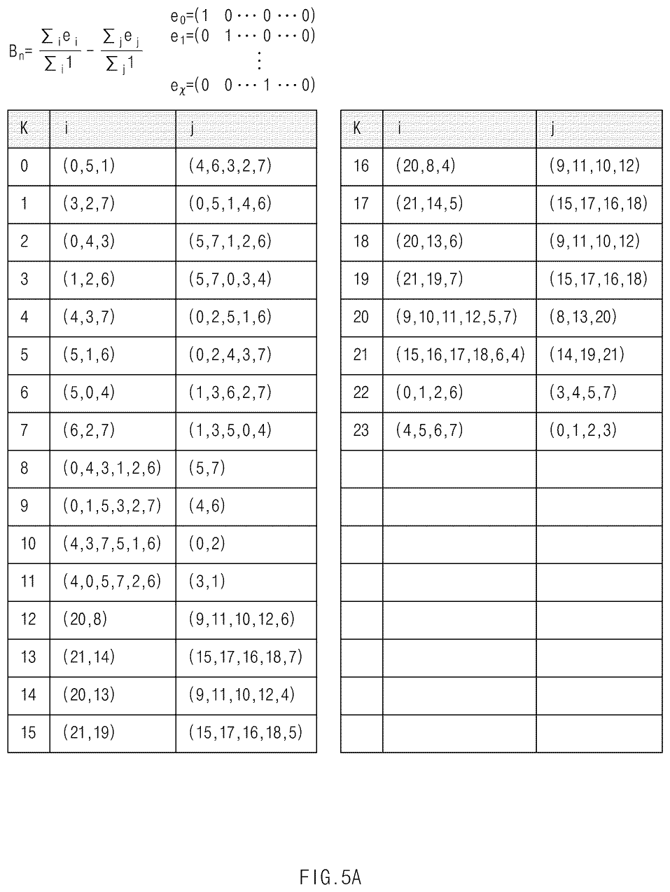

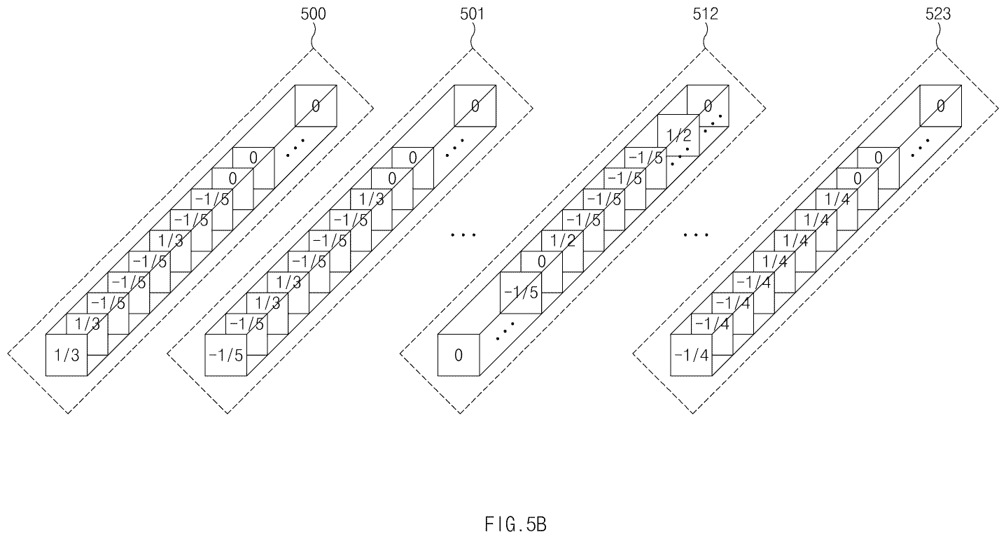

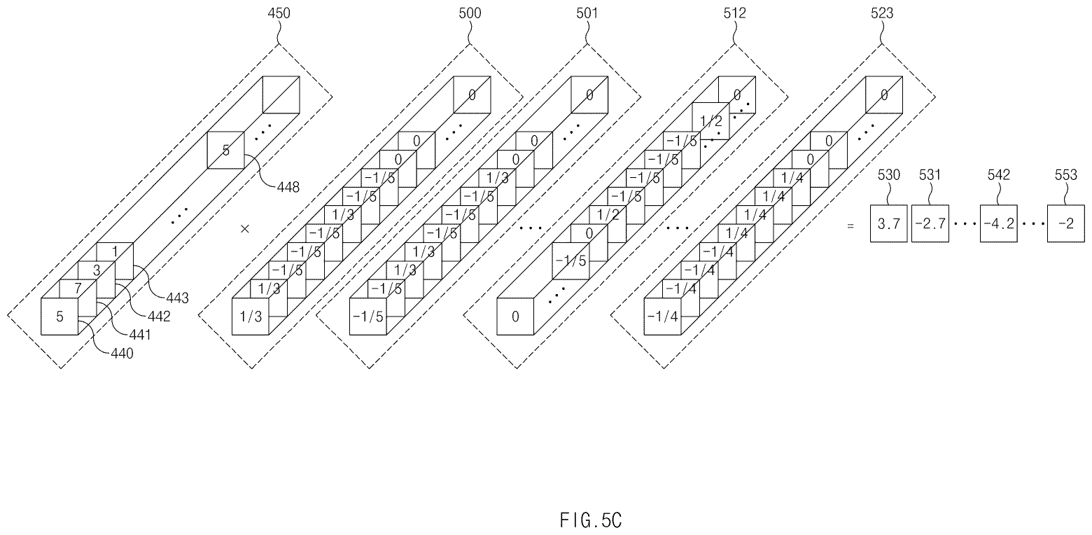

FIG. 5A illustrates a formula showing a plurality of cost kernels based on some embodiments of the present disclosure.

Referring to FIG. 5A, a plurality of cost kernels based on some embodiments of the present disclosure may be expressed as a kernel corresponding to a (1×n) matrix. For example, the first cost kernel may correspond to ‘K=0’ depicted in the table of FIG. 5A. In some embodiments, Bₙ may correspond to an equation for calculating a cost kernel, e may be a determinant used for the Bₙ equation, i may be a determinant for identifying an e determinant located at the left of Bₙ, and j may be a determinant for identifying an e determinant located at the right of Bₙ. In some embodiments, based on the Bₙ formula, at k=0, uses 0, 5, 1 as the i values, the sum of e_i corresponds to (1 0 0 0 0 . . . )+(0 0 0 0 0 . . . )+(0 1 0 0 0 0 . . . )=(1 1 0 0 0 1 . . . ), the result divided by the number of i (e.g., 3) can be located in the left term of Bₙ. In some embodiments, based on the Bₙ formula, at k=0, uses 4, 6, 3, 2, 7 as the j values, the sum of e_j corresponds to (0 0 0 0 1 0 0 0 . . . )+(0 0 0 0 0 0 0 1 0 . . . )+(0 0 0 1 0 0 0 0 . . . )+(0 0 1 0 0 0 0 0 . . . )+(0 0 0 0 0 0 0 1 . . . )=(0 0 1 1 1 0 1 1 . . . ), the result divided by the number of j (e.g., 5) can be located in the right term of Bₙ. According to the formula indicating the value of Bₙ, the first cost kernel may be expressed as a kernel corresponding to a matrix denoted by “(1 1 0 0 0 1 0 0 0 0 . . . )/3−(0 0 1 1 1 0 1 1 0 0 . . . )/5=(1/3 1/3 −1/5 −1/5 −1/5 1/3 −1/5 −1/5 0 0 . . . )”. For example, the second cost kernel may correspond to ‘k=1’ depicted in the table of FIG. 5A. According to the formula indicating the value of Bₙ, the second cost kernel may be expressed as a kernel corresponding to a matrix denoted by “(0 0 1 1 0 0 0 1 0 0 . . . )/3−(1 1 0 0 1 1 1 0 0 0 . . . )/5=(−1/5 −1/5 1/3 1/3 −1/5 −1/5 −1/5 0 0 0 . . . )”. For example, the 17^{th} cost kernel may correspond to ‘k=16’ depicted in the table of FIG. 5A. According to the formula indicating the value of Bₙ, the 17^{th} cost kernel may be expressed as a kernel corresponding to a matrix denoted by “(0 0 0 0 1 0 0 0 1 0 0 0 0 0 0 0 0 0 0 0 1 . . . )/3−(0 0 0 0 0 0 0 0 0 1 1 1 1 0 0 0 0 0 0 0 0 . . . )/4=(0 0 0 0 1/3 0 0 0 1/3 −1/4 −1/4 −1/4 −1/4 0 0 0 0 0 0 0 1/3 . . . )”.

In one example, each of the plurality of cost kernels may be multiplied by a weight. For example, the first cost kernel may be obtained by multiplying the value of ‘−1’ by (1/3 1/3 −1/5 −1/5 −1/5 1/3 −1/5 −1/5 0 0 . . . ), and may be expressed as a kernel corresponding to the matrix denoted by “(−1/3 −1/3 1/5 1/5 1/5 −1/3 1/5 1/5 0 0 . . . )”. For example, the second cost kernel may be obtained by multiplying the value of ‘0’ by (−1/5 −1/5 1/3 1/3 −1/5 −1/5 −1/5 0 0 0 . . . ), and may be expressed as a kernel corresponding to the matrix denoted by “(0 0 0 0 0 0 0 0 0 0 . . . )”. The weight value may be a preset value to reflect elements including at least one of lens, sensor, color, arrangement, imbalance, crosstalk, etc.

FIG. 5B is a diagram illustrating a plurality of cost kernels based on some embodiments of the present disclosure.

Referring to FIG. 5B, examples of cost kernels (500˜523) corresponding to the formula of FIG. 5A are shown. The cost kernels shown in FIG. 5B may be expressed as a kernel corresponding to a (1×n) matrix, where ‘n’ may correspond to the number of directional components included in the directional components of FIG. 4B (e.g., 450 of FIG. 4B). In one example, the first cost kernel 500 may correspond to ‘k=0’ depicted in the table of FIG. 5A, and the number of directional components included in the directional components 450 of FIG. 4B is 26 corresponding to the number of directional kernels of FIG. 4A. Therefore, according to the formula indicating the value of Bₙ, the first cost kernel 500 may be expressed as a kernel corresponding to a kernel corresponding to a matrix denoted by “(1/31/3 −1/5 −1/5 −1/5 1/3 −1/5 −1/5 0 0 0 0 0 0 0 0 0 0 0 0 0 0 0 0 0 0)”. In one example, the 17^{th} cost kernel 516 may correspond to ‘k=16’ depicted in the table of FIG. 5A, and the number of directional components included in the directional components 450 of FIG. 4B is 26 corresponding to the number of directional kernels of FIG. 4A. Therefore, according to the formula indicating the value of Bₙ, the 17^{th} cost kernel may be expressed as a kernel corresponding to a kernel corresponding to a matrix denoted by “(0 0 0 0 1/3 0 0 0 1/3 −1/4 −1/4 −1/4 −1/4 0 0 0 0 0 0 0 1/3 0 0 0 0 0)”.

In one example, the first cost kernel 500 may correspond to a cost kernel that extracts the first directional component 440 (see FIG. 4B), the second directional component 441 (see FIG. 4B), and the sixth directional component (not shown) as positive average values while extracting the third to fifth directional components (442, etc.) (see FIG. 4B), the seventh directional component (not shown), and the eighth directional component (not shown) as negative average values. The first cost kernel 500 may be multiplied by a first weight after being affected by sensor characteristics or the like. In one example, the second cost kernel 501 may correspond to a cost kernel that extracts the third directional component 442 (see FIG. 4B), the fourth directional component 443 (see FIG. 4B), and the eighth directional component (not shown) as positive average values while extracting the first directional component 440 (see FIG. 4B), the second directional component 441 (see FIG. 4B), and the fifth to seventh directional components (not shown) as negative average values. The second cost kernel 501 may be multiplied by a second weight after being affected by sensor characteristics or the like.

In addition, although in the present embodiment the cost kernel (e.g., 500) is implemented as a kernel corresponding to a (1×26) matrix for convenience of description, the scope or spirit of the disclosed technology is not limited thereto, and it should be noted that more diverse directional components can be reflected into a kernel having a larger size than the example kernel. In addition, although in the present embodiment 24 cost kernels are used for convenience of description, the cost can be extracted by combining directional components in more diverse ways when using many more cost kernels than the number of example cost kernels. A convolution operation based on some embodiments of the present disclosure can also be applied substantially in the same way to these cost kernels.

FIG. 5C is a diagram illustrating a method for performing the operation S120 shown in FIG. 3 based on some embodiments of the present disclosure.

Referring to FIG. 5C, the interpolation kernel determiner 122 may perform a convolution operation between each of the cost kernels (e.g., 500, 501, 512, 523) and the directional components 450 of FIG. 4B, and may extract the costs (530˜553). For example, in order to extract the costs (530˜553) from the directional components 450, the interpolation kernel determiner 122 may extract the first cost 530 by performing a convolution operation between the first cost kernel 500 and the directional components 450. At this time, with respect to the directional components 450 and the first cost kernel 500, the interpolation kernel determiner 122 may perform a point-wise convolution operation in which the directional components 450 are matched to channel(s) and the first cost kernel 500 is matched to a unit kernel. For example, the convolution resultant value obtained by performing a convolution operation between the first cost kernel 500 and the directional components 450 may correspond to “5×(1/3)+7×(1/3)+3×(−1/5)+1×(−1/5)+1×(−1/5)+4×(1/3)+3×(−1/5)+0×(−1/5)+5×0+6×0 . . . =3.7”, and data of the first cost 530 may be defined as “3.7”.

In one example, in order to extract the costs (530˜553) from the directional components 450, the interpolation kernel determiner 122 may extract the second cost 531 by performing a convolution operation between the second cost kernel 501 and the directional components 450. At this time, with respect to the directional components 450 and the second cost kernel 501, the interpolation kernel determiner 122 may perform a point-wise convolution operation in which the directional components 450 are matched to channel(s) and the second cost kernel 501 is matched to a unit kernel. For example, the convolution resultant value obtained by performing a convolution operation between the second cost kernel 501 and the directional components 450 may correspond to “5×(−1/5)+7×(−1/5)+3×(1/3)+1×(1/3)+1×(−1/5)+4×(−1/5)+3×(−1/5)+0×(1/3)+5×0+6×0 . . . =−2.7”, and data of the second cost 531 may be defined as “−2.7”.

In one example, in order to extract the costs (530˜553) from the directional components 450, the interpolation kernel determiner 122 may extract the 13^{th} cost 542 by performing a convolution operation between the 13^{th} cost kernel 512 and the directional components 450. At this time, with respect to the directional components 450 and the 13^{th} cost kernel 512, the interpolation kernel determiner 122 may perform a point-wise convolution operation in which the directional components 450 are matched to channel(s) and the 13^{th} cost kernel 512 is matched to a unit kernel. For example, the convolution resultant value obtained by performing a convolution operation between the 13^{th} cost kernel 512 and the directional components 450 may correspond to “5×0+7×0+3×0+1×0+1×0 +4×0+3×(−1/5)+0×0+5×(1/2)+6×(−1/5)+3×(−1/5)+8×(−1/5)+2×(−1/5)+3×0+3×0+5×0+1×0+5×0+7×0+2×0+1×(1/2)+2×0+5×0+1×0=−1.4”, and data of the 13^{th} cost 542 may be defined as “−4.2”.

The interpolation kernel determiner 122 may extract an index value by applying the function “Arg max” or “Arg min” to the first cost 530 to the 24th cost 553 (e.g., S130 of FIG. 3). The index value may correspond to the number of each cost kernel. For example, when the first cost 530 from among the first to 24^{th} costs (530˜553) has a maximum value, the interpolation kernel determiner 122 may extract the value of ‘1’ as an index number by applying the function “Arg max” to the 24^{th} cost 553, and may identify the first cost kernel 500. For example, when the 13^{th} cost 542 from among the first to 24^{th} costs (530˜553) has a minimum value, the interpolation kernel determiner 122 may extract the value of 13 as an index number by applying the function “Arg min” to the first to 24^{th} costs (530˜553).

In some embodiments, the interpolation kernel determiner 122 may determine the interpolation kernel based on values obtained by performing a convolution operation between each of the cost kernels (500˜523) and the directional components 450. In one example, each of the cost kernels (500˜523) may include a preset weight as data. In one example, the values obtained by performing a convolution operation between each of the cost kernels (500˜523) and the directional components 450 may be the resultant values of a point-wise convolution operation in which the directional components 450 are matched to channel(s) and each of the cost kernels (500˜523) is matched to a unit kernel. In one example, the interpolation kernel may be an interpolation kernel corresponding to a cost kernel that derives a maximum or minimum value from among the convolution resultant values obtained by performing a convolution operation between each of the cost kernels (500˜523) and the directional components 450.

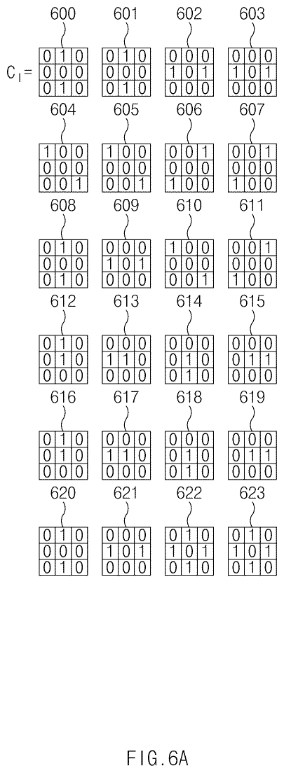

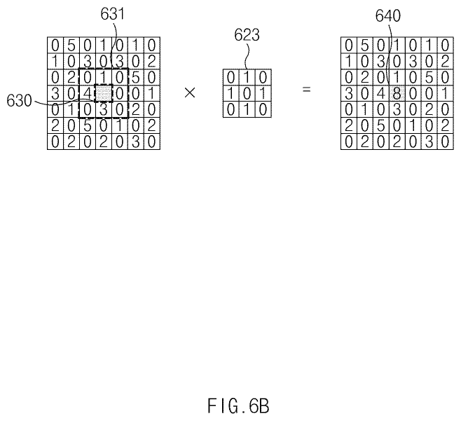

FIG. 6A is a diagram illustrating a plurality of interpolation kernels based on some embodiments of the present disclosure.

Referring to FIG. 6A, examples of the interpolation kernels (600˜623) are shown. C_I is a symbol for multiple interpolation kernels, for example, C_0 corresponds to the first interpolation kernel 600. The pixel interpolator 123 may perform a convolution operation between the target kernel and one of the interpolation kernels (600˜623) such that the center of the interpolation kernels (600˜623) corresponds to the target pixel (DP). In one example, the pixel interpolator 123 may perform a convolution operation between the target kernel and the interpolation kernel such that the center of the interpolation kernels corresponds to the target pixel (DP). In one example, the interpolation kernel for interpolating the target pixel (DP) may correspond to an index value obtained by applying the function “Arg max” or “Arg min” to the first to 24^{th} costs (530˜553) (e.g., S140 of FIG. 3). For example, the index value may correspond to the number of each cost kernel. One interpolation kernel may correspond to each cost kernel. For example, when the first cost 530 from among the first to 24^{th} costs (530˜553) has a maximum value, the interpolation kernel determiner 122 may extract the value of 1 as an index number by applying the function “Arg max” to the first to 24^{th} costs (530˜553), and may determine the first interpolation kernel 600 corresponding to the first cost kernel 500 to be an interpolation kernel corresponding to the target pixel (DP). For example, when the 13^{th} cost 542 from among the first to 24^{th} costs (530˜553) has a minimum value, the interpolation kernel determiner 122 may extract the value of 13 as an index number by applying the function “Arg min” to the first to 24^{th} costs (530˜553), and may determine the 13^{th} interpolation kernel 612 corresponding to the 13^{th} cost kernel 512 to be an interpolation kernel corresponding to the target pixel (DP). The interpolation kernels shown in FIG. 6A are merely examples, and in the present embodiment a kernel is a (3×3) kernel, but more diverse interpolation kernels may exist in a kernel having a larger size than the example kernels. The interpolation operation based on some embodiments of the present disclosure can be applied substantially in the same way to these interpolation kernels.

FIG. 6B is a diagram illustrating a method for performing the operation S150 shown in FIG. 3 based on some embodiments of the present disclosure.

Referring to FIG. 6B, the pixel interpolator 123 may interpolate the defective pixel 630 by performing a convolution operation between the interpolation kernel 623 and the neighboring pixels 631 of the defective pixel 630. The pixel interpolator 123 may perform a convolution operation so that the center of the interpolation kernel corresponds to the target pixel (DP). For example, in order to interpolate the defective pixel 630, the pixel interpolator 123 may perform a convolution operation between the interpolation kernel 623 and the neighboring pixels 631 of the defective pixel 630, and may obtain the interpolated pixel data 640 of the defective pixel 630. At this time, the convolution resultant value obtained by performing a convolution operation between the interpolation kernel 623 and the neighboring pixels 631 of the defective pixel 630 may correspond to “0×0+1×1+0×0+4×1+0×1+0×0+3×1+0×0=8”, and the interpolated pixel data 640 of the defective pixel 630 may be defined as ‘8’.

In one example, the number of neighboring pixels 631 of the defective pixel 630 used for convolution may vary depending on the size of the interpolation kernel.

For example, when the interpolation kernel has a (5×5) kernel, the neighboring pixels of the defective pixel 630 to be used for convolution may sequentially correspond to “0, 3, 0, 3, 0, 2, 0, 1, 0, 5, 0, 4, 0, 0, 1, 0, 3, 0, 2, 0, 5, 0, 1, 0” arranged in the order from the upper-left side of the defective pixel 630, and may correspond to the size of a (5×5) kernel.

In some embodiments, the pixel interpolator 123 may enable the target pixel to correspond to data located at the center of the interpolation kernel. Further, the pixel interpolator 123 may determine a convolution resultant value obtained by performing a convolution operation between the target kernel and the interpolation kernel to be pixel data of the target pixel.

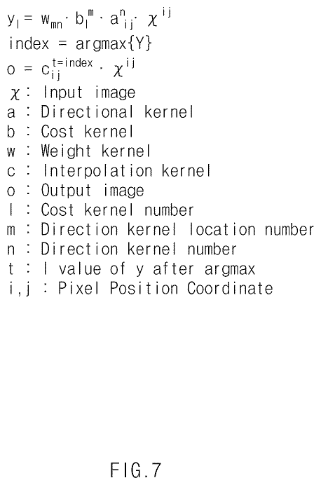

FIG. 7 illustrates a formula showing the entire process of interpolating one pixel based on some embodiments of the present disclosure.

Referring to FIG. 7, interpolated pixel data of a defective pixel according to one example may be derived. In the formula according to one example, ‘x’ may be defined as the input image, ‘a’ may be defined as the directional kernel, ‘b’ may be defined as the cost kernel, ‘w’ may be defined as a weight kernel that includes a weight as data, ‘y’ may be defined as a cost, ‘c’ may be defined as an interpolation kernel, and ‘o’ may be defined as an output image. In the formula according to one example, ‘I’ may be defined as a cost kernel number, ‘m’ may be defined as a directional kernel location number, ‘n’ may be defined as a directional kernel number, and ‘t’ may be defined as a cost kernel ID number (l) to be derived as the function “Arg max{Y}”, and (i, j) may be defined as pixel coordinates. In one example ‘l’ may be defined as a cost kernel identification (ID) number, ‘m’ may be defined as a directional kernel position number

In one example, x^{i,j} may be defined as pixel data of a pixel located at coordinates (i, j) of the input image. In one example, the input image may correspond to a target kernel. In one example, when x^{i,j} corresponds to a defective pixel, the image signal processor 100 may set the value of x^{i,j} to the value of ‘0’. In one example, when x^{i,j} corresponds to a defective pixel, the image signal processor 100 may not use the value of x^{i,j} in the calculation process. For example, x^{1,2} may be defined as pixel data of a pixel located in first row and second column of the input image. Referring again to FIG. 4B, when the kernel including the target pixel 430 is the input image, x^{1,1} can be defined as zero ‘0’. For example, referring again to FIG. 4B, when a kernel including the target pixel 430 is an input image, the target pixel 430 may correspond to x^{4,4}. At this time, the image signal processor 100 may set the value of x^{4,4} to zero ‘0’. Alternatively, the image signal processor 100 may not use the value of x^{4,4} in the calculation process.

In one example, a_{i,j}ⁿ, may be defined as data located at the coordinates (i, j) of the n-th directional kernel. In one example, when x^{i,j} corresponds to a defective pixel, the image signal processor 100 may set the value of a_{i,j}ⁿ to zero ‘0’. In one example, when x^{i,j} corresponds to a defective pixel, the image signal processor 100 may not use the value of a_{i,j}ⁿ in the calculation process. For example, a_{1,1}¹ may be defined as data located at a first-row-and-first-column position of the first directional kernel. Referring back to FIG. 4A, for example, the first directional kernel 400 may correspond to a_{i,j}¹. At this time, a_{i,j}¹ may be defined as the value of ‘1’. In addition, a_{3,3}¹ may be defined as zero ‘0’. For example, the 24^{th} directional kernel 423 may correspond to a_{i,j}²⁴. At this time, a_{4,7}²⁴ may be defined as the value of ‘1’. Further, a_{5,7}²⁴ may be defined as zero ‘0’.

In one example, (a_{i,j}ⁿ·x^{i,j}) may be defined as a convolution resultant value obtained by performing a convolution operation between pixel data of a pixel located at the coordinates (i, j) and data located at the coordinates (i, j) of the directional kernel. Referring back to FIG. 4B, for example, (a_{i,j}¹·x^{i,j}) may correspond to a convolution resultant value (i.e., 0×1+1×1+0×0+4×1+0×0+0×0+3×0+0×0=5) obtained by performing a convolution operation between the first directional kernel 400 and pixel data of the neighboring pixels 431 corresponding to the size of the first directional kernel 400 with respect to the target pixel 430, and (a_{i,j}¹·x^{i,j}) may be defined as the first directional component 440. For example, (a_{i,j}⁹·x^{i,j}) may correspond to a convolution resultant value (i.e., in FIG. 4B, 0×0+3×1+0×0+3×0+0×0+2×1+0×1+1×0+0×0+5×0+0×0+4×0+0×0+0×0 +1×0+0×0+3×0+0×0+2×0+0×0+5×0+0×0+1×0+0×0=5) obtained by performing a convolution operation between the ninth directional kernel 408 and pixel data of the neighboring pixels 432 corresponding to the size of the ninth directional kernel 408 with respect to the target pixel 430, and (a_{i,j}⁹·x^{i,j}) may be defined as the ninth directional component 448.

In one example, bₗ^{m} may be defined as the m-th data of the l-th cost kernel. For example, b₁¹ may be defined as the first data of the first cost kernel (e.g., 500 of FIG. 5B). Referring back to FIG. 5B, for example, the first cost kernel 500 may correspond to b₁^{m}. At this time, b₁¹ may be defined as ‘1/3’. In addition, b₁³ may be defined as ‘−1/5’. For example, in FIG. 5B, the 24^{th} cost kernel 523 may correspond to b₂₄^{m}. At this time, b₂₄¹ may be defined as ‘−1/4’. Additionally, b₂₄⁹ may be defined as zero ‘0’.

In one example, wₘₙ may be defined as a weight corresponding to either the m-th data of the cost kernel or the n-th data of the directional component from among the data of the weight kernel. For example, w₁₁ may be defined as a weight corresponding to the first data of the cost kernel and the first data of the directional component. For example, referring again to FIG. 5C, w₁₁ may be defined as a weight that is multiplied by a plurality of first data (i.e., 1/3, −1/5, ( . . . ), 0, ( . . . ), −1/4) of the first to 24^{th} cost kernels (500˜523). In one example, w₁₁ may be defined as a weight that is multiplied by the first directional component 440. In some embodiments, for convenience of description, since each of the cost kernels (500˜523) and the directional components 450 are subjected to a point-wise convolution operation, the number (m) of data digits of the cost kernel are equal to the number (n) of data digits of the directional component. However, in other convolution operations other than the point-wise convolution operation, ‘m’ may be different from ‘n’.

In one example, yₗ may be defined as the l-th cost (Cost #1). For example, y₁ may be defined as a point-wise convolution resultant value obtained by performing a point-wise convolution operation between the first cost kernel 500 and the directional components 450. Referring back to FIG. 5C, for example, y₁ may correspond to a convolution (i.e., point-wise convolution) resultant value obtained by performing a convolution (i.e., point-wise convolution) operation between the first cost kernel 500 and the directional components 450, and y₁ may be defined as the first cost 530. For example, y₁₃ may be defined as a point-wise convolution resultant value obtained by performing a point-wise convolution operation between the 13^{th} cost kernel and the directional components 450. For example, y₁₃ may correspond to a convolution (i.e., point-wise convolution) resultant value (i.e., Referring to 450 and 512 of FIG. 5C, 5×0+7×0+3×0+1×0+1×0+4×0+3×(−1/5)+0×0+5×(1/2)+6×(−1/5)+3×(−1/5)+8×(−1/5)+2×(−1/5)+3×0+3×0+5×0+1×0+5×0+7×0 +2×0+1×(1/2)+2×0+5×0+1×0=−1.4) obtained by performing a convolution (i.e., point-wise convolution) operation between the 13^{th} cost kernel 512 and the directional components 450, and y₁₃ may be defined as the 13^{th} cost 542.

In one example, the index number can be defined as the result

of applying the function “Arg max” or “Arg min” to the set (or aggregate) that has y₁ serving as an element. For example, when y₁₃ from among y₁ to y₂₄ has a maximum value, the interpolation kernel determiner 122 may extract ‘13’ as the index number by applying the function “Arg max” to the set (or aggregate) including y₁˜y₂₄. For example, when y₂₄ from among y₁ to y₂₄ has a minimum value, the interpolation kernel determiner 122 may extract ‘24’ as the index number by applying the function “Arg min” to y₁ ˜y₂₄.

In one example, c_{i,j}^{t} may be defined as data located at the coordinates (i, j) of the t^{-th} interpolation kernel, where ‘t’ is defined as an index number extracted from the function “Arg max” or “Arg min”. For example, c_{1,1}¹ may be defined as data located at the first-row-and-first-column position of the first interpolation kernel (i.e., interpolation kernel #1). Referring back to FIG. 6A, for example, the first interpolation kernel 600 may correspond to c_{i,j}¹. At this time, c_{1,1}¹ may be defined as zero ‘0’, and c_{1,2}¹ may be defined as the value of ‘1’. For example, the 12^{th} interpolation kernel 611 may correspond to c_{i,j}¹². At this time, c_{1,3}¹² may be defined as the value of ‘1’, and c_{3,1}¹² may be defined as the value of ‘1’.

In one example, ‘o’ may be defined as an output image. ‘o’ may be defined as a convolution resultant value obtained by performing a convolution operation between pixel data of a pixel located at the coordinates (i, j) of the input image and data corresponding to the coordinates (i, j) of the interpolation kernel. Referring back to FIG. 6B, for example, (c_{i,j}²⁴·x^{i,j}) may correspond to a convolution resultant value (i.e., 0×0+1×1+0×0+4×1+0×1+0×0+3×1+0×0=8) obtained by performing a convolution operation between the 24^{th} interpolation kernel 623 and pixel data of the neighboring pixels 631 corresponding to the size of the 24^{th} interpolation kernel 623, and ‘o’ may be defined as (c_{i,j}^{t}·x^{i,j}) . In one example, interpolation of defective pixel(s) may be performed according to the order of general convolution operations. In more detail, one defective pixel may be interpolated according to the interpolation method of the present embodiment, and the next defective pixel may then be interpolated according to the interpolation method of the present embodiment.

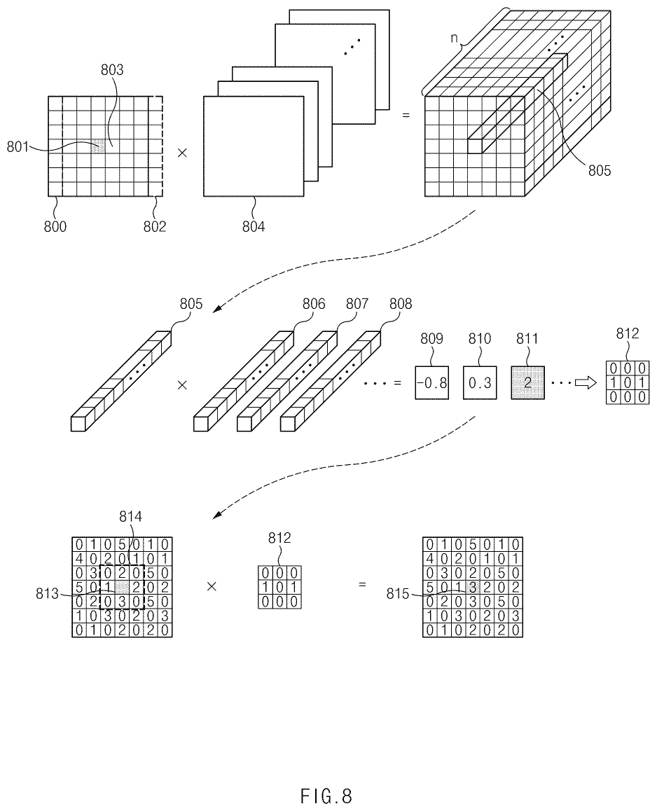

FIG. 8 is a diagram illustrating the entire process of interpolating one pixel based on some embodiments of the present disclosure.

Referring to FIG. 8, when the target pixel 801 included in the target kernel 800 corresponds to a defective pixel, the target pixel 801 may be interpolated with pixel data 815 interpolated according to the interpolation method of the present embodiment. After the defective pixel is interpolated according to the interpolation method of the present embodiment, the image signal processor 100 may change the target kernel and the target pixel. For example, after the target pixel 801 is interpolated with the interpolated pixel data 815, the image signal processor 100 may set a second target pixel 803, and may set a second target pixel 802 including the second target pixel 803.

In one example, the target kernel 800 may include a target pixel 801. The target pixel 801 may be a pixel located at the center of the target kernel 800. The image signal processor 100 may extract the directional components 805 of the target kernel 800 to interpolate the target pixel 801. For example, the directional component extractor 121 may extract the directional components 805 by performing a convolution operation between the target kernel 800 and each of the first kernels 804. The first kernels 804 may include the first to 26^{th} directional kernels (400˜425) of FIG. 4A. For example, the directional component extractor 121 may extract the first directional component by performing a convolution operation between the target kernel 800 and the first directional kernel, and may extract the second directional component by performing a convolution operation between the target kernel 800 and the second directional kernel. In one example, the directional component extractor 121 may sequentially stack the directional components 805, and may store the stacked result as data formed in a 3D stack kernel shape. For example, when the number of directional kernels is ‘n’, the directional component extractor 121 may store N directional components as data formed in a 3D stack kernel shape.

In one example, the image signal processor 100 may extract costs (e.g., 809, 810, 811) of the target kernel 800 to interpolate the target pixel 801. For example, the interpolation kernel determiner 122 may extract the costs (e.g., 809, 810, 811) by performing a convolution operation between each of the directional components 805 and each of the second kernels (e.g., 806, 807, 808). In another example, the second kernels may include the first to the 24^{th} cost kernels (500˜523) of FIG. 5B. For example, the interpolation kernel determiner 122 may extract the first cost 809 by performing a point-wise convolution operation between the first cost kernel 806 and the directional components 805. Further, the interpolation kernel determiner 122 may extract the second cost 810 by performing a point-wise convolution operation between the second cost kernel 807 and the directional components 805.

In one example, the image signal processor 100 may determine an interpolation kernel (e.g., 812) corresponding to the target kernel 800 in order to interpolate the target pixel 801. For example, the interpolation kernel determiner 122 may extract the index number by applying the function “Arg max” or “Arg min” to the costs (e.g., 809, 810, 811). For example, when the third cost 811 from among the extracted costs (e.g., 809, 810, 811) corresponds to the highest value and the interpolation kernel determiner 122 applies the function “Arg max” to the extracted costs (e.g., 809, 810, 811), the interpolation kernel determiner 122 may extract ‘3’ as the index number corresponding to the third cost. At this time, the interpolation kernel determiner 122 may determine the third interpolation kernel 812 corresponding to the index number ‘3’ to be the interpolation kernel corresponding to the target kernel 800.

In one example, the image signal processor 100 may perform a convolution operation between the target kernel and the interpolation kernel 812 to interpolate the target pixel 801. The defective pixel 813 shown in FIG. 8 can be understood to be in correspondence with the target pixel 801 included in the target kernel 800. For example, the pixel interpolator 123 may perform a convolution operation so that the center of the interpolation kernel 812 corresponds to the defective pixel 813. For example, in order to interpolate the defective pixel 813, the pixel interpolator 123 may perform a convolution operation between the interpolation kernel 812 and the neighboring pixels 814 of the defective pixel 813, and may obtain interpolated pixel data 815 of the defective pixel 813. At this time, the convolution resultant value obtained by performing a convolution operation between the interpolation kernel 812 and the neighboring pixels 814 of the defective pixel 813 may correspond to “0×0+2×0+0×0+1×1+2×1+0×0+3×0+0×0=3”, and the interpolated pixel data 815 of the defective pixel 813 may be defined as ‘3’.

In some embodiments, as shown in FIG. 2, the image signal processor 100 may include the directional component extractor 121, the interpolation kernel determiner 122, and the pixel interpolator 123. The directional component extractor 121 may extract the directional components 805 of the target kernel by performing a first convolution operation between the target kernel including a target pixel and each of the first kernels. The interpolation kernel determiner 122 may determine the interpolation kernel based on convolution resultant values obtained by performing a second convolution operation between each of the second kernels and the directional components 805. The pixel interpolator 123 may interpolate the target pixel using data included in the interpolation kernel. In one example, the first convolution operation may refer to an operation to be performed in a state in which the target pixel is matched to data located at the center of each of the first kernels. In one example, the second convolution operation may refer to a point-wise convolution operation in which the directional components 805 are matched to channel(s) and each of the second kernels is matched to a unit kernel. In one example, the interpolation kernel may refer to an interpolation kernel corresponding to a kernel that derives a maximum or minimum value from among the second convolution resultant values from among the kernels included in the second kernels.

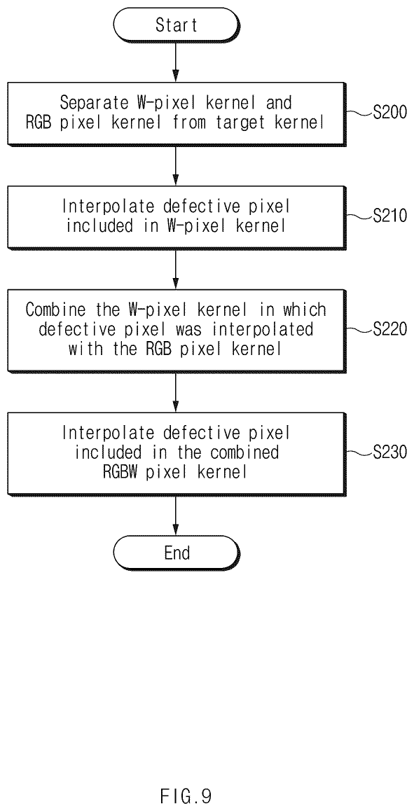

FIG. 9 is a flowchart illustrating a method for interpolating the target kernel by classifying kernels by color based on some embodiments of the present disclosure.

Referring to FIG. 9, the image signal processor 100 may divide the input image into pixels having the first color filters, pixels having the second color filters, and pixels having the third color filters, such that the target kernels can be classified into the first color kernels, the second color kernels, and the third color kernels.

For example, when pixels corresponding to different colors (e.g., red, green, blue, white) in the original image captured by the image sensing device are arranged according to an RGBW color pattern, the image signal processor 100 may classify kernels of the original image into a red-pixel (R-pixel) kernel including pixels each having only a red color filter, a green-pixel (G-pixel) kernel including pixels each having only a green color filter, a blue-pixel (B-pixel) kernel including pixels each having a blue color filter, and a white-pixel (W-pixel) kernel including pixels each having a white filter. For example, the image signal processor 100 may separate the W-pixel kernel, which has the relatively largest number of pixels, from the RGB pixel kernel (S200).

In one example, the image signal processor 100 may interpolate the defective pixel included in the W-pixel kernel by using the W-pixel kernel as a target kernel. At this time, the image signal processor 100 may determine pixel data located at a position corresponding to a pixel having RGB color filters from among the W pixel kernels to be zero ‘0’. Alternatively, at this time, the image signal processor 100 may determine pixel data of the directional kernel located at a position corresponding to the pixel having the RGB color filters from among the W-pixel kernels to be zero ‘0’. For example, in order to interpolate the defective pixel included in the W-pixel kernel by using the W-pixel kernel as a target kernel, the image signal processor 100 may perform the interpolation operation disclosed in FIGS. 4A to 8 (S210).

In one example, the image signal processor 100 may perform interpolation of defective pixels included in the W-pixel kernel by using the W-pixel kernel as a target kernel, and may combine the interpolated W-pixel kernel with the RGB pixel kernel isolated from. For example, the image signal processor 100 may interpolate all defective pixels included in the W-pixel kernel, may combine the interpolated W-pixel kernel with the RGB pixel kernel separated in operation S200, and may generate an RGBW pixel kernel (S220). In one example, among pixels included in the RGBW pixel kernel, pixels with R, G, or B color filters may include defective pixels.

In one example, the image signal processor 100 may interpolate the defective pixels included in the RGBW pixel kernel by using the RGBW pixel kernel as a target kernel. For example, in order to interpolate the defective pixels included in the RGBW pixel kernel by using the RGBW pixel kernel as a target kernel, the image signal processor 100 may perform the interpolation operation shown in FIGS. 4A to 8 (S230).

In one example, the image signal processor 100 may use either data of the directional components (e.g., 450 of FIG. 4B) used when the defective pixels included in the W-pixel kernel are interpolated using the W-pixel kernel as a target kernel, or data of the costs (e.g., 530 to 533 of FIG. 5C), and may interpolate the defective pixels included in the RGB pixel kernel by using the RGB pixel kernel as a target kernel.

In one example, the image signal processor 100 may interpolate defective pixels included in the RGBW pixel kernel using the RGBW pixel kernel as a target kernel. Further, the image signal processor 100 may generate a Bayer pattern image, which is an RGB pattern, based on the interpolated RGBW pixel kernel. For example, in order to interpolate defective pixels included in the RGBW pixel kernel using the RGBW pixel kernel as a target kernel, the image signal processor 100 may perform the interpolation operation shown in FIGS. 4A to 8, and may generate the Bayer pattern image, which is the RGB pattern, based on the interpolated RGBW pixel kernel.

In some embodiments, the directional component extractor 121 may extract directional components using pixel data of pixels each having the first color filter from among pixels included in the target kernel. In one example, the directional component extractor 121 may determine pixel data of pixels each having a color filter different from the first color filter, from among pixels included in the target kernel, to be zero ‘0’. In one example, among data included in the plurality of directional kernels, data corresponding to the position of a pixel having a color filter different from the first color filter may be set to zero ‘0’.

In some embodiments, the image signal processing method may include extracting first directional components of a first color kernel by performing a convolution operation between the first color kernel having a first target kernel and each of a plurality of directional kernels; determining a first interpolation kernel based on the first directional components; and interpolating the first target pixel using data included in the first interpolation kernel. In one example, the image signal processing method may further include generating an interpolated target kernel by mixing an interpolated first color kernel including an interpolated first target pixel with a second color kernel. In one example, the image signal processing method may include extracting second directional components of the interpolated target kernel by performing a convolution operation between the interpolated target kernel including a second target pixel and each of a plurality of directional kernels; determining a second interpolation kernel based on the second directional components; and interpolating the second target pixel using data included in the second interpolation kernel. The image signal processing method may further include determining a first interpolation kernel based on convolution resultant values obtained by performing a convolution operation between the first directional components and each of the cost kernels. In one example, the image signal processing method may further include multiplying each of the cost kernels by a preset weight. In one example, the image signal processing method may include performing a point-wise convolution operation in which the first directional components correspond to the channels and each of the cost kernels corresponds to a unit kernel.

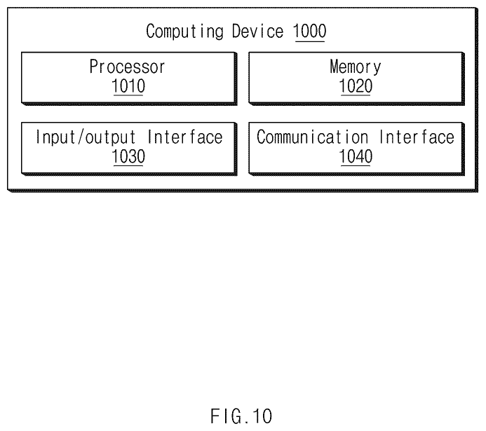

FIG. 10 is a block diagram showing a computing device 1000 corresponding to the image signal processor of FIG. 1.

Referring to FIG. 10, the computing device 1000 may represent an embodiment of a hardware configuration for performing the operation of the image signal processor 100 of FIG. 1.

The computing device 1000 may be mounted on a chip that is independent from the chip on which the image sensing device is mounted. According to one embodiment, the chip on which the image sensing device is mounted and the chip on which the computing device 1000 is mounted may be implemented in one package, for example, a multi-chip package (MCP), but the scope of the disclosed technology is not limited thereto.

Additionally, the internal configuration or arrangement of the image sensing device and the image signal processor 100 described in FIG. 1 may vary depending on the embodiment. For example, at least a portion of the image sensing device may be included in the image signal processor 100. Alternatively, at least a portion of the computing device 1000 may be included in the image sensing device. In this case, at least a portion of the computing device 1000 may be mounted together on a chip on which the image sensing device is mounted.

The computing device 1000 may include a processor 1010, a memory 1020, an input/output interface 1030, and a communication interface 1040.

The processor 1010 may process data and/or instructions required to perform the operations of the components (110, 120) of the image signal processor 100 described in FIG. 1. That is, the processor 1010 may refer to the image signal processor 100, but the scope of the disclosed technology is not limited thereto.

The memory 1020 may store data and/or instructions required to perform operations of the components (110, 120) of the image signal processor 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image signal processor 100 disclosed in this document is recorded in the memory 1020 and executed and processed by the processor 1010, thereby implementing the operations of the image signal processor 100.

The input/output interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, external memory, etc.), and may be a device that supports wired or wireless communication.

As is apparent from the above description, the image signal processor and the image signal processing method based on some embodiments of the present disclosure may analyze directional components included in a target kernel, may interpolate the target kernel based on an interpolation kernel corresponding to the target kernel, and may thus increase the accuracy of correction for defective pixels even when multiple directional components are included in the target kernel.

The embodiments of the present disclosure may provide a variety of effects capable of being directly or indirectly recognized.

Although a number of illustrative embodiments have been described, it should be understood that modifications and enhancements to the disclosed embodiments and other embodiments can be devised based on what is described and/or illustrated in the present disclosure Therefore, the scope of the present disclosure should not be limited to the above-described embodiments but should include the equivalents thereof.

In the above-described embodiments, all operations may be selectively performed, or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. An image signal processor comprising:
a directional component extractor configured to extract directional components of a target kernel by performing a convolution operation between the target kernel including a target pixel and each of a plurality of directional kernels;
an interpolation kernel determiner configured to determine an interpolation kernel based on the directional components; and
a pixel interpolator configured to interpolate the target pixel using data included in the interpolation kernel.

2. The image signal processor according to claim 1, wherein
the interpolation kernel determiner is configured to obtain convolution resultant values by performing a convolution operation between each of a plurality of cost kernels and the directional components, and determine the interpolation kernel based on the convolution resultant values.

3. The image signal processor according to claim 2, wherein
each of the plurality of cost kernels includes a preset weight.

4. The image signal processor according to claim 2, wherein
the convolution resultant values include result values obtained by performing a point-wise convolution operation in which the directional components are matched to channel and each of the plurality of cost kernels is matched to a unit kernel.

5. The image signal processor according to claim 2, wherein
the interpolation kernel includes an interpolation kernel corresponding to a cost kernel that derives a maximum or minimum value from among the convolution resultant values.

6. The image signal processor according to claim 1, wherein
the directional component extractor is configured to extract the directional components by using pixel data of each pixel having a first color filter from among pixels included in the target kernel.

7. The image signal processor according to claim 6, wherein
the directional component extractor is configured to determine, as a particular value, pixel data of each pixel having a color filter different from the first color filter from among pixels included in the target kernel.

8. The image signal processor according to claim 6, wherein
the directional component extractor is configured to determine, as a particular value, data corresponding to a position of each pixel having a color filter different from the first color filter from among data included in the plurality of directional kernels.

9. The image signal processor according to claim 1, wherein
the target kernel has the same size as the largest directional kernel from among the plurality of directional kernels.

10. The image signal processor according to claim 1, wherein the pixel interpolator is configured to:
match, to the target pixel, data located at a center of the interpolation kernel; and
determine, as pixel data of the target pixel, a convolution resultant value between the target kernel and the interpolation kernel.

11. An image signal processor comprising:
a directional component extractor configured to extract directional components of a target kernel by performing a first convolution operation between the target kernel and each of a plurality of first kernels, the target kernel including a target pixel;
an interpolation kernel determiner configured to obtain convolution resultant values by performing a second convolution operation between each of a plurality of second kernels and the directional components, and determine an interpolation kernel based on the convolution resultant values; and
a pixel interpolator configured to interpolate the target pixel using data included in the interpolation kernel.

12. The image signal processor according to claim 11, wherein
the first convolution operation is performed in a state in which the target pixel is matched to data located at a center of each of the plurality of first kernels.

13. The image signal processor according to claim 11, wherein
the second convolution operation is a point-wise convolution operation in which the directional components are matched to a channel and each of the plurality of second kernels is matched to a unit kernel.

14. The image signal processor according to claim 11, wherein
the interpolation kernel refers to an interpolation kernel corresponding to a kernel that derives a maximum or minimum value among the convolution resultant values obtained by the second convolution operation, from among kernels included in the plurality of second kernels.

15. An image signal processing method comprising:
extracting first directional components of a first color kernel by performing a convolution operation between the first color kernel and each of a plurality of directional kernels, the first color kernel including a first target pixel;
determining a first interpolation kernel based on the first directional components; and
interpolating the first target pixel using data included in the first interpolation kernel.

16. The image signal processing method according to claim 15, further comprising:
generating an interpolated target kernel by mixing an interpolated first color kernel with a second color kernel, the interpolated first color kernel including an interpolated first target pixel.

17. The image signal processing method according to claim 16, further comprising:
extracting second directional components of the interpolated target kernel by performing a convolution operation between each of the directional kernels and the interpolated target kernel including a second target pixel;
determining a second interpolation kernel based on the second directional components; and
interpolating the second target pixel using data included in the second interpolation kernel.

18. The image signal processing method according to claim 15, wherein the determining the first interpolation kernel includes
obtaining convolution resultant values by performing a convolution operation between each of a plurality of cost kernels and the first directional components, and
determining the first interpolation kernel based on the convolution resultant values.

19. The image signal processing method according to claim 18, wherein the determining the first interpolation kernel further includes
multiplying each of the plurality of cost kernels by a preset weight.

20. The image signal processing method according to claim 18, wherein the obtaining the convolution resultant values includes
performing a point-wise convolution operation by matching the first directional components to channel and matching each of the plurality of cost kernels to a unit kernel.
